(19) United States
(12) Patent Application Publication
(10) Pub. No.: US 2015/0375122 A1
(43) Pub. Date: Dec. 31, 2015

(54) SYSTEMS AND METHODS FOR CONTROLLING MULTIPLE ACCOUNTS

(71) Applicant: KING.COM LIMITED, St. Julians (MT)

(72) Inventors: Patrik Stymne, Stockholm (SE); Jonas Olofsson, Stockholm (SE); Jan Zetterman, Stockholm (SE); Magnus Ornebring, Stockholm (SE)

(21) Appl. No.: 14/316,216

(22) Filed: Jun. 26, 2014

(51) Int. Cl. A63F 13/79

(52) U.S. Cl. CPC A63F 13/79

(57) ABSTRACT

A computer implemented method and system is described for controlling multiple identities. The system comprises at least one user device operable to communicate with at least one server of the system via a communication link, the server having at least one processor and at least one memory connected to at least one datastore storing a plurality of user identities, the method comprising detecting a trigger event associated with a second user identifier, the trigger event providing a second user identifier different to a first user identifier, associating the second user identifier with said first user identifier, and providing for at least one game associated with the first user identifier and the second user identifier a common set of game data.

### FIELD OF THE INVENTION

Some embodiments may relate to methods and systems for controlling two or more accounts in an online gaming environment.

### BACKGROUND OF THE INVENTION

The modern world is becoming a ubiquitous connected world, with users registered, or not, with certain services. Such services may require unique login and password information, and as is becoming increasingly familiar to the users, they may have to manage many such accounts for various services.

A user may have several devices, or indeed points of access to, in the user's view, the same application. This is particularly relevant to social gaming applications, where a user or player may register once (via a laptop for example), play the same game application via a social networking platform and/or on another device of the user (e.g. smartphone, tablet, google glass).

Thus some users may have two or more different accounts for the same game application. This may occur in the world of social media, where users may play games, on such social platforms in addition to playing the same games offered by the service provider on the service provider's platform.

### SUMMARY OF THE INVENTION

According to a first aspect, there is provided a computer implemented method in a system comprising at least one user device operable to communicate with at least one server of the system via a communication link, the server having at least one processor and at least one memory connected to at least one data store storing a plurality of user identities, the method comprising detecting a trigger event associated with a second user identity, the trigger event providing the second user identity different to a first user identifier, associating the second user identifier with said first user identifier, and providing for at least one game associated with the first user identifier and the second user identifier a common set of game data.

In an embodiment, the detecting of said trigger even occurs whilst the game is active and wherein the first user identifier is in use.

In another embodiment the common set of game data is provided for said game.

In another embodiment, subsequent detection and activation of a different game responsive to said activation is provided, providing for said different game a common set of data.

In yet another embodiment, said trigger event comprises providing information indicative of said second user identifier while said game is active.

In another embodiment, said trigger event comprises logging into a social networking site.

In an embodiment, the at least one identifier comprises an email address.

In an embodiment, the at least one at least one identifier comprises a social networking site identifier.

In another embodiment, the provision of the common set of game data is dependent on a comparison of game data associated with the first user identifier and game data associated with the second user identifier.

In yet another embodiment, for at least one type of game data comprises a better value which is provided in said common set of data.

In another embodiment, for at least one type of game data a more recent value is provided in said set of common data.

In an embodiment, for at least one type of game data a combined value is provided in said set of common data.

In another embodiment, said game data may comprise one or more of score, level, date, time, in game currency, in game-purchased assets, boosters, lives.

In yet another embodiment, the game data corresponding to at least one of currency and in-game purchased assets may be updated and synchronised between the first and second user identifier securely.

In another embodiment, the secure mechanism comprises an RSA encryption algorithm.

According to another aspect, there is provided a server operable to communicate with at least one at least one user device via a communication link, the server having at least one processor and at least one memory connected to at least one datastore storing a plurality of user identities, the server being configured to detect a trigger event associated with a second user identifier, the trigger event providing a second user identifier different to a first user identifier, associate the second user identifier with said first user identifier, and provide for at least one game associated with the first user identifier and the second user identifier a common set of game data.

In an embodiment of the above aspect, the server may be further configured to receive said second identifier, associate said second identifier with the first identifier in response to said trigger event, and store said second identifier associated with said first identifier in said datastore.

In another aspect there is provided a user device operable to communicate with at least one server of a gaming system via a communication link, the server having at least one processor and at least one memory connected to at least one database holding a data structure storing a plurality of user identities, the user device having at least one processor and at least one memory storing at least a first user identifier, one set of game data associated with a gaming application and the first user identifier, wherein the user device provides a second user identifier as a trigger event to the server.

In an embodiment of the above aspect, the common set of game data associated with the first and second identifier is updated upon detection of said trigger event to provide the common set of game data.

In yet a further aspect, there is provided computer program code on a carrier, which when executed by at least one processor of a server, causes the at least one processor to detect a trigger event associated with a second user identity, the trigger event providing the second user identity different to a first user identifier, associate the second user identifier with said first user identifier, and provide for at least one game associated with the first user identifier and the second user identifier a common set of game data.

Other aspects and features are described with reference to the appended claims.

### BRIEF DESCRIPTION OF DRAWINGS

To understand some embodiments, reference will now be made by way of example only to the accompanying drawings, in which:

FIG. 1 shows an example client or user device of an embodiment;

FIG. 2 illustrates an example system in which some embodiments may be provided;

FIG. 3 shows more detail of an example system according to some embodiments;

FIG. 4 illustrates data structures according to some embodiments;

FIG. 5 is a diagram illustrating linking and updating according to some embodiments;

FIG. 6 depicts a flowchart of a method according to an embodiment; and

FIG. 7A illustrates a data structure according to an embodiment and FIG. 7B illustrates steps in a flowchart according to an embodiment; and

FIG. 8 is diagram of a flowchart according to an embodiment.

### DETAILED DESCRIPTION OF THE INVENTION

Casual or social gaming is a relevant recent trend that is growing. Candy Crush, and Candy Crush 2, Bubble Witch saga and Papa Pear are examples of the applicant's games and services that are incredibly popular with millions of users worldwide.

Such games are made available by applicant across many platforms. For example one may play via a website using any suitable device such as a desktop PC or laptop. One may also play on the same devices or different devices via a social network such as Facebook™ or Google+, for example, via the internet. A user may use more than one device (for example, a smart phone, a tablet, PC or laptop) to access the same or different applications on the same platform.

An anonymous account may be enabled if the user wishes to play directly with the service provider. This may be provided on a per game basis in some embodiments. The user may have an account which allows the user to access one or more games. The account will be specific to the user and will have user identity information and optionally a password. The user identity information may be an email address and/or other form of identity information. The user may play the game via a social media site or the like. In the case of Facebook, the user identity information will be the Facebook identity.

The inventors have recognised that a problem exists in that a service provider of games for example, may have more than one account associated with a user but the service provider has no knowledge of this.

Another problem is that a user may be playing the same game using different accounts. Accordingly, progress or the like achieved by playing via one account will not be apparent if the user the plays the game using a different account.

For example, some game applications provided by the service provider may encourage friends to link up and play by for instance providing buttons or icons within the application or user interface that enables the user to input their social network identifier, for example. If the user subsequently wishes to play, or is invited to play, the same or a different game via the social network, then because the user may have more than one account, any game progress information will be from the account currently used by the user and not necessarily their best progress.

Some embodiments may address some of these issues.

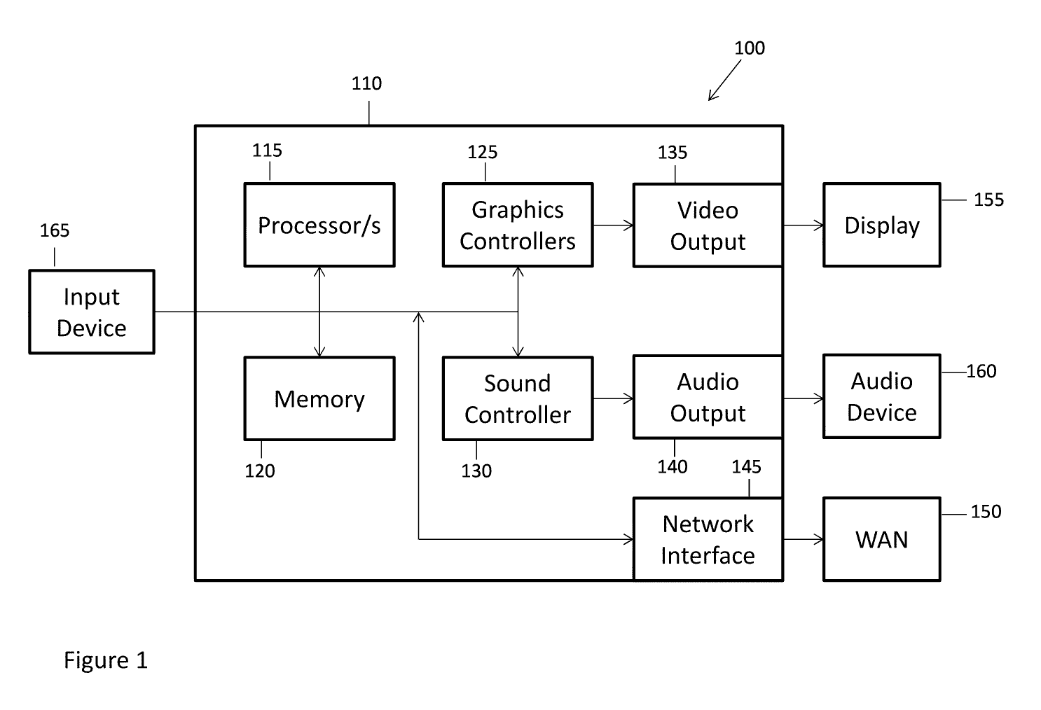

A schematic view of a client or user device 100 according to an embodiment is shown in FIG. 1. All of the blocks shown are implemented by suitable circuitry. The blocks may be implemented in hardware and/or software. The user device may have a control part 110. The control part 110 has one or more processors 115 and one or more memories 120. The control part 110 is also shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The controller 110 has an interface 145 allowing the device to be able to communicate with a network 150 such as the Internet or other communication infrastructure.

The video output 135 is provided to a display 155. The audio output 140 is provided to an audio device 160 such as a speaker and/or earphone(s).

The device 100 has an input device 165. The input device 165 can take any suitable format and can be one or more of a keyboard, mouse, touch screen, joystick or game controller. It should be appreciated that the display 155 may in some embodiments also provide the input device 165 by way of an integrated touch screen for example.

The blocks of the controller 110 are configured to communicate with each other by an interconnect such as a bus or any other suitable interconnect and/or by point to point communication.

It should be appreciated that in some embodiments, the controller 110 may be implemented by one or more integrated circuits, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

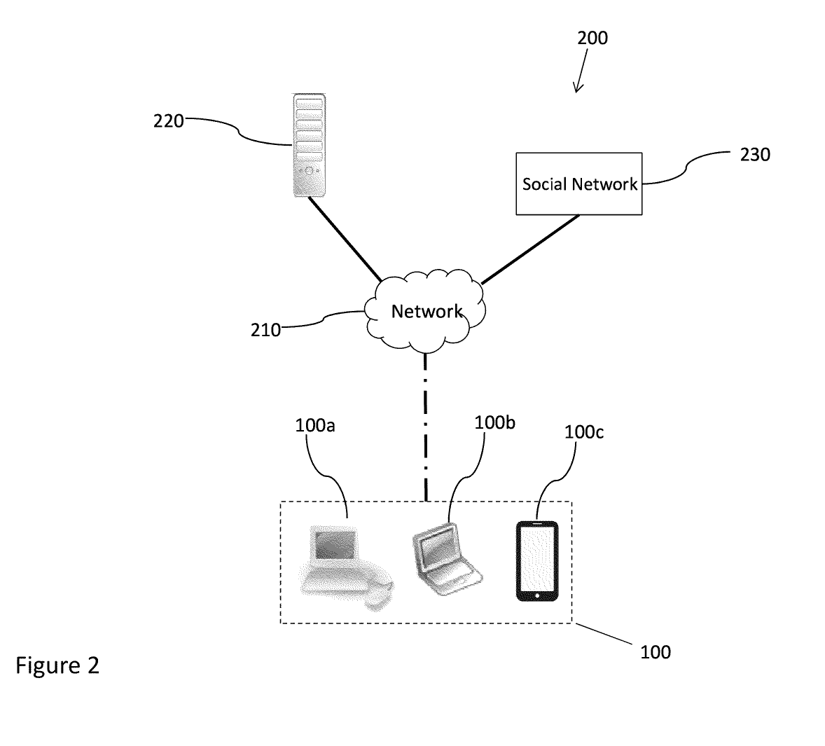

FIG. 2 schematically shows a system 200 in some embodiments. The system 200 comprises a server 220 which may store or be in communication with databases 250 which may be, in some embodiments, connected to a back end infrastructure 240 (“BEN”) of game player's details, profiles, statistics, etc. In practice, one or more databases 250 may be provided. Where more than one server 220 is provided, the database(s) 250 may be provided in one database 250 or across two or more servers 220, 310. The server 220 may also have a games data function. This may comprise one or more units of memory to store the computer game program and user behaviour data, and a processor to run the games program and process the user behaviour data.

The server 220 may communicate via for instance the internet 210 to one or more client or user devices 100, shown in the figure by way of example as user devices 100a, 100b and 100c, and may further provide connections to a social network 230 such as Facebook™.

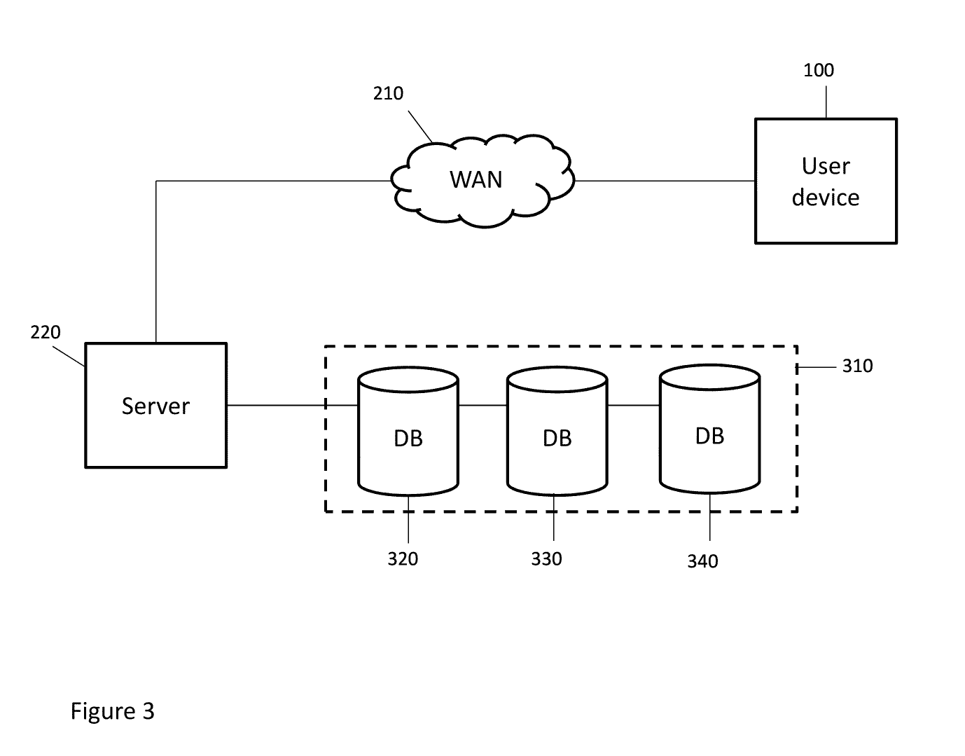

FIG. 3 expands on the system of FIG. 2, in which the server 220 is connected via a network and/or WAN (wide area network) 210 to a user device 100. The system and server 220 is also connected to a database 310. The database entity 310 comprises databases 320, 330, 340 and may be described as a database farm.

The databases 320, 330, 340 may be located in the same location, and/or maybe physically distant to each other as will be recognised by those skilled in the art.

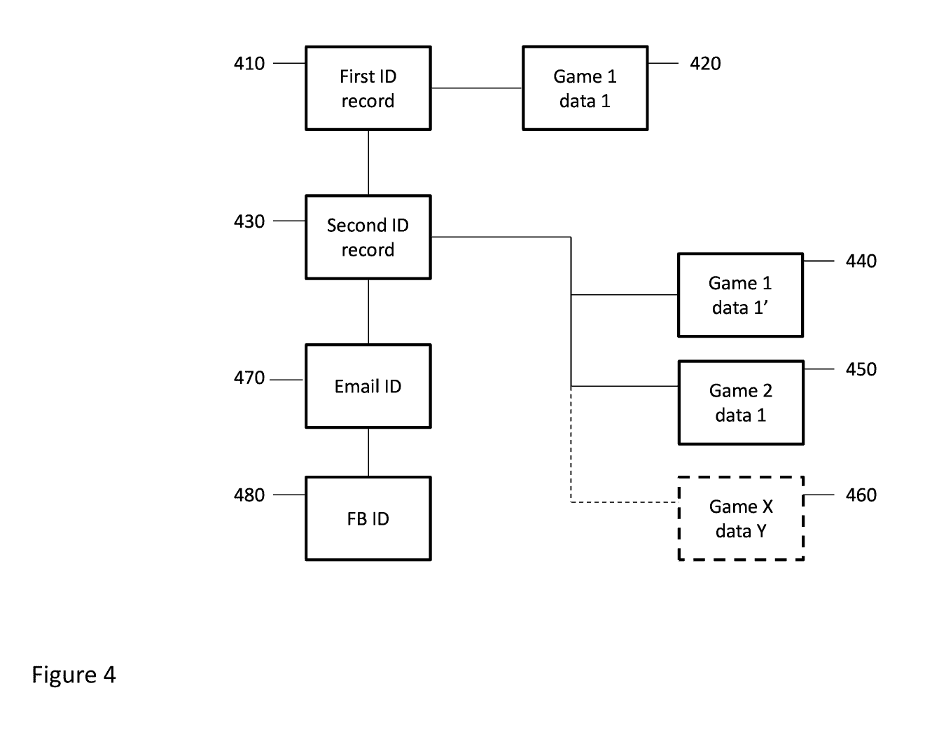

FIG. 4 schematically shows an example of data records which may be stored in the database farm 310. FIG. 4 shows the first ID record 410 linked to “game1 data1” 420. For example, the player may have initially registered and downloaded the game application “Candy Crush” of applicant.

Database may also store a second ID record 430 itself linked to game one data that is different to the game one data one of the first ID record 410. This is indicated in the figure, by way of example only as “Game1 data1’. Similarly the second ID record 430 may also be linked or associated with different game data of another game, for example “game2 data1” 450. The second ID record 430 may also store other game data as indicated in the diagram by “GameX dataY” 460.

In an example, the “game1 data1” data may relate to a game of applicants such as Candy Crush™. The “game2 data1” may relate to a different application provided by the applicant, such as Pepper Pear Saga.

FIG. 4 also illustrates that the same user or player may have other accounts, such as a third ID account 470 and fourth ID account. One or more of these accounts may be one registered with the service provider via an email address 470, or a social media networking identity such as provided by Facebook™ or for example Google+ or be an anonymous account which is tied to the downloading of a game on a specific device without having any user information (egg requiring the user to register or having social media information). These accounts are regarded by the service provider as being separate accounts. There is thus no synchronising of such accounts to ensure that the user or player has a seamless “follow me” experience.

For example, a user may begin playing a game on their mobile phone whilst commuting, but then may access the same game via their desktop PC or laptop at work, and may then play the same game in the evening at home on their tablet such as iPad or Android tablet.

Furthermore, using the scenario above, the user or player may download or access a new game application, which user may then access when convenient and appropriate, and time permitting, on other devices accessible to the user.

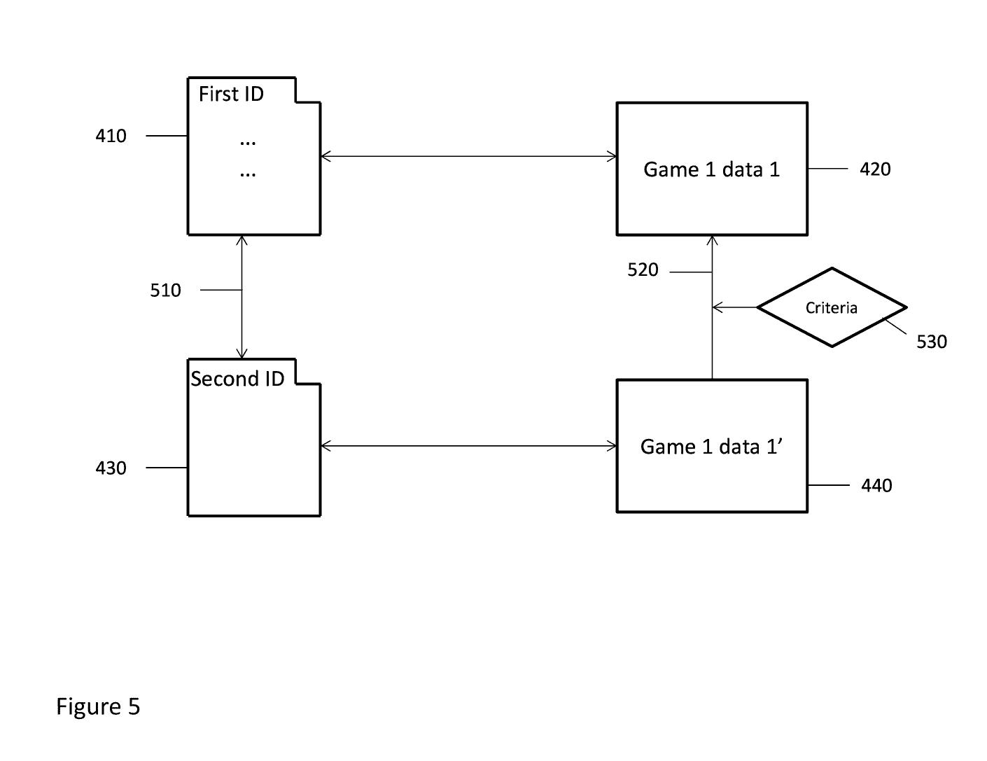

FIG. 5 illustrates an exemplary database structure which, in an embodiment enables such synchronisation between two or more accounts belonging to the same user.

Database 310 may store records as indicated by FIG. 5 in an embodiment. The records may be stored in a relational database, or may be linked via any other suitable mechanism.

FIG. 5 illustrates in an embodiment how data may be organised within the server farm or data store 310. FIG. 5 shows a first ID record 410 linked with first game data, “game1data1” 420. A second ID record 430 is also linked by link 510 to the first ID 410.

The second ID 430 is associated with “game1data1’ “(i.e. updated data as to status, progression, score and so on of game 1) 440 as shown in the figure. As will be described later, the decision as to whether to update the game1 data 1 420 with the game1 data1′ 440 is dependent on the processing provided at the server side as indicated schematically by criteria 530 via path 520 as shown in FIG. 5.

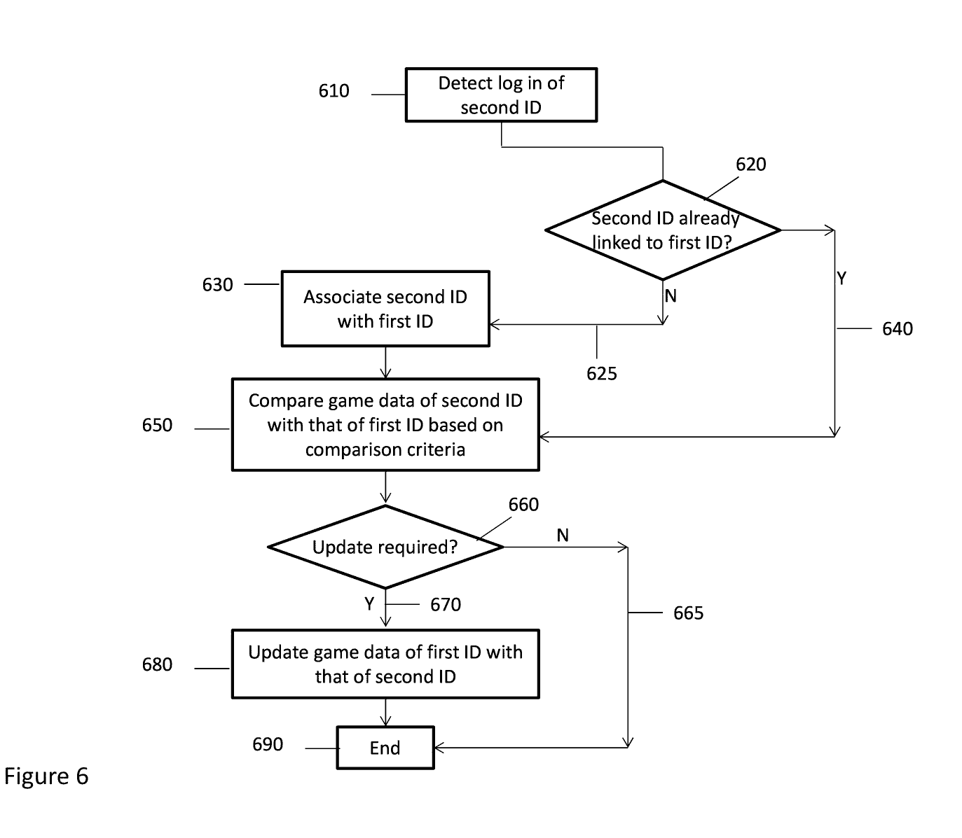

An embodiment of a method bringing the foregoing together will now be described with reference to the flowchart of FIG. 6.

Referring to FIG. 6, at step 610 the client or user device 100a, 100b, 100c is currently logged into a game and is using a first identity. The user device may be logged in using for example an anonymous account or an account associated with the user (egg using an email address). The user may whilst in that game log into a second account of that same user. This may occur if the user follows a prompt to connect to friends on a social media site. For example the user may be prompted via the device to connect to his Facebook account. The server will be aware of the first account being used by the user when the user then logs onto another account of the user. The server will thus detect the new or second login ID. The server then, at step 620, compares the second ID to those stored in the server or database farm or store 310.

If the second ID is not known and not already linked or associated with the first ID, then the server proceeds via path 625 to step 630 wherein the second ID is associated or linked to the first ID of the user. The two IDs can thus be identified by the server as belonging to the same user and thus connected.

In step 650, the game data of second identity is compared with the game data of the first identity. The comparison 650 may comprise comparing one or more of score, date, time, progress indicators, level, lives remaining, stars and any other such in-game assets as may be available. This will be described in more detail later.

The comparison 650 will reveal whether or not an update of game data (step 660) from the second ID to the first ID or vice versa is necessary. If so, the server proceeds to step 670 wherein new or altered game data associated with the first identity is updated 680 to that of the second identity or vice versa.

At step 660, if an update is not required, then the method proceeds via path 665 to step 690 wherein the process terminates.

It should be appreciated that in some embodiments, the game data is synchronised on a per game basis. For example the game data may be synchronised for the first game whilst that first user is playing the first game application or the like. The game data for any other games is not changed in some embodiments at this stage. Accordingly, if the user accounts have been linked and the game data for a first game is not currently synchronised, when the user next accesses a second game application, the server will note that there is an account linked to the user's account. The server will then carry out steps 650 to 690 in respect of the game data for the second game. This may be repeated each time the user accesses a game for which the game data has not been previously synchronised.

It should be appreciated that the illustrated method has described the synchronising of two accounts. It should be appreciated that some embodiments may be used to synchronise three or more accounts.

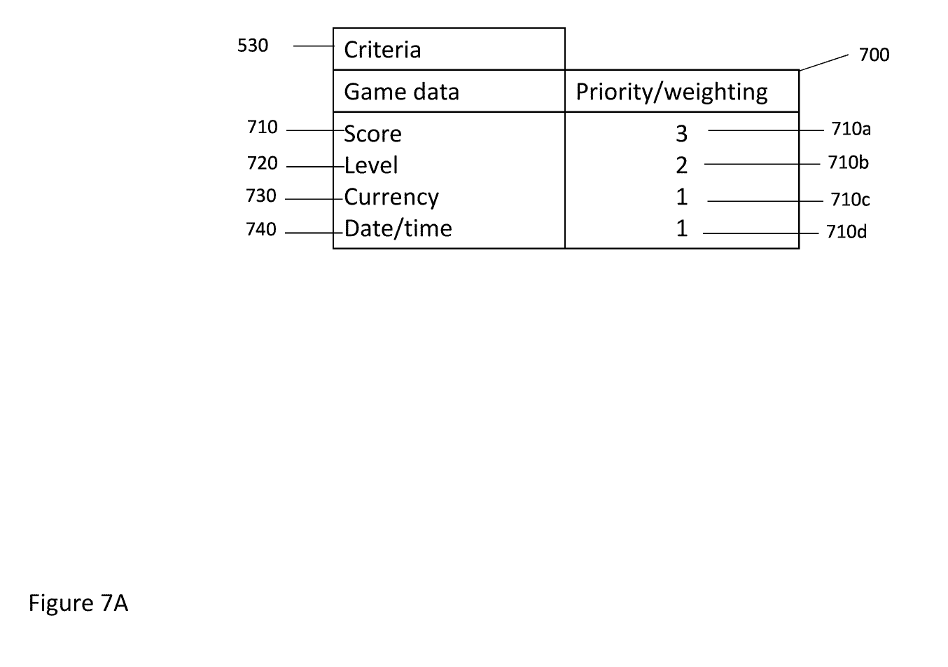

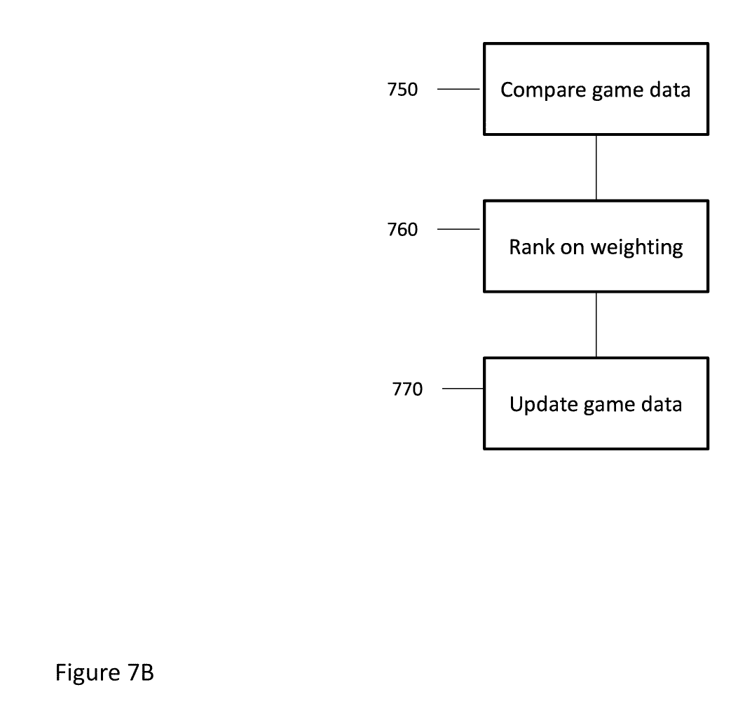

FIG. 7A illustrates an example data structure 700 stored in the database farm 310 comprising game data and criteria for comparison. Record 530 may be linked or associated with linked and/or associated user IDs (referring to the same user) as previously described.

The record of FIG. 7A relates to a single application or game, for instance “game1data1” 420. Record 700 may be produced from the records of both of the user's identities which are being linked. Fields in the record may comprise one or more of score 710, level 720, currency/money in game purchases 730 and date/time of the above 740.

Record 700 also, for each entry 710, 720,730,740 stores a priority or weighting for each entry. By way of example, FIG. 7A indicates that the current score 710 in a game application has a weighting of 3 710a, the current level 720 has an increased weighting of 2 710b, whereas currency 730 or date/time 740 have the highest priority or weighting 710c, 710d respectively.

These priorities or rankings may be used in some embodiments when comparing game data to decide whether or not an update is required, and if so, in what order.

FIG. 7B shows some steps of a method in which the at least one processor 115, 220 compares game data as previously described at step 750, retrieves the weighting or ranking coefficients 710a, 710b, 710c, 710d, and updates the appropriate game data accordingly at step 770.

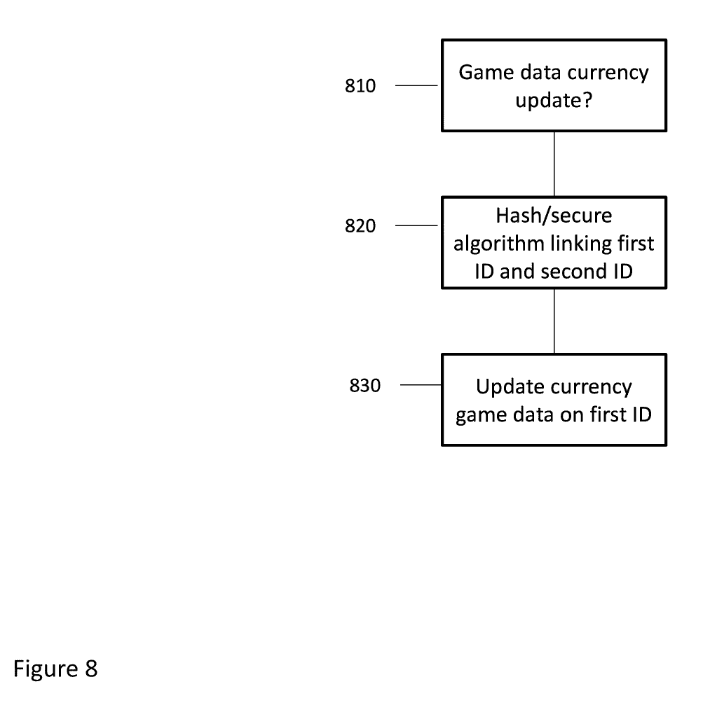

FIG. 8 illustrates steps of a method embodiment relating to handling and synchronising in-game or virtual world currency.

At step 810 of FIG. 8, the at least one processor 115, 220, in determining that a currency update is required (for example the user has paid money for extras available as per the game) moves to step 820 wherein a secure algorithm for linking the currency data is applied. In one embodiment, this involves generating typical RSA2 keys and hashing the first and second account IDs with the amount (for example) to ensure a secure transaction.

Some embodiments may simply compare the data of at least one field and select the data with the better value as the resulting data. For example, better data may be a higher level, a higher number of points or a higher number of lives. In some embodiments, alternatively or additionally the data from the two accounts may be added together. For example, number of boosters purchased or in game currency. In some embodiments, alternatively or additionally data with a later time stamp may be kept as the resulting data.

In some embodiments, the user will be asked if they would like to synchronise the data between two or more of his accounts. If the user does not want the accounts to be synchronised, then the game data is not synchronised but nonetheless the accounts will be linked. In some embodiments, the user will be asked to choose from which account the resulting data is to be provided. In some embodiments, an algorithm at the server will make the decision as to the resulting game data.

It should be appreciated that the data can be stored in any suitable way. For example, each user identity may have a core identity. Game data may be stored in association with the core identity. When a second account is linked to the first, the second account will no longer be associated with its core identity but will instead point to the core identity of the first account.

In other embodiments, there is no core identity and rather one user identity will have data associated with it to point to the data of the other identity.

In some embodiments, the data is synchronised but is stored separately against each identity.

In some embodiments, where the data is synchronised on a per game basis, information is stored to indicate whether or not synchronisation of that game has occurred. In some embodiments, the information indicates that synchronisation has occurred and the lack of this information indicates that synchronisation has not occurred.

Accordingly, when it is determined that two or more accounts are linked, a determination is made as to whether the data for a particular game has been synchronised when game is activated (for example by selecting a game or playing it). It should be appreciated that information may be stored in any suitable manner to indicate if the data has been synchronised or not.

It should be appreciated that after the data for a game from two or more different accounts has been synchronised, when a user next plays the game, the synchronised data is updated.

It should be appreciated that in some embodiments reference has been made to a server causing the accounts to be linked and processing the game data. It should be appreciated that this may be carried out by at least one processor and at least one memory configured to store computer code which when run may cause any of the methods described previously to be performed. It should be appreciated that any other suitable circuitry and/or device may be configured to perform any of the methods described above.

A person skilled in the art will realise that the different approaches to implementing the apparatus, systems, device and installations disclosed herein are not exhaustive, and what is described herein are certain preferred embodiments. It is possible to implement the way in a number of variations without departing from the spirit or scope of the invention.

1. A computer implemented method in a system comprising at least one user device operable to communicate with at least one server of the system via a communication link, the server having at least one processor and at least one memory connected to at least one data store storing a plurality of user identities, the method comprising:
detecting a trigger event associated with a second user identity, the trigger event providing the second user identity different to a first user identifier,
associating the second user identifier with said first user identifier, and
providing for at least one game associated with the first user identifier and the second user identifier a common set of game data.

2. A method as claimed in claim 1, comprising detecting said trigger event while a game is active, said first user identifier being in use.

3. A method as claimed in claim 2, wherein said common set of game data is provided for said game.

4. A method as claimed in claim 3, comprising subsequently detecting activation of a different game and responsive to said activation, providing for said different game a common set of data.

5. A method according to claim 2, wherein said trigger event comprises providing information indicative of said second user identifier while said game is active.

6. A method as claimed in claim 1, wherein said trigger event comprises logging into a social networking site.

7. A method according to claim 1, wherein at least one identifier comprises an email address.

8. A method as claimed in claim 1, wherein at least one identifier comprises a social networking site identifier.

9. A method according to claim 1, wherein providing the common set of game data is dependent on a comparison of game data associated with the first user identifier and game data associated with the second user identifier.

10. A method as claimed in claim 1, wherein for at least one type of game data a better value is provided in said common set of data.

11. A method as claimed in claim 1, wherein for at least one type of game data a more recent value is provided in said set of common data.

12. A method as claimed in claim 1, wherein for at least one type of game data a combined value is provided in said set of common data.

13. A method according to claim 1, wherein said game data comprises one or more of score, level, date, time, in game currency, in game-purchased assets, boosters, lives.

14. A method according to claim 13, wherein the game data corresponding to at least one of currency and in-game purchased assets is updated and synchronised between the first and second user identifier securely.

15. A method according to claim 14, wherein the secure mechanism comprises an RSA encryption algorithm.

16. A server operable to communicate with at least one at least one user device via a communication link, the server having at least one processor and at least one memory connected to at least one datastore storing a plurality of user identities, the server being configured to:
detect a trigger event associated with a second user identifier,
the trigger event providing a second user identifier different to a first user identifier,
associate the second user identifier with said first user identifier, and
provide for at least one game associated with the first user identifier and the second user identifier a common set of game data.

17. A server as claimed in claim 16, further configured to receive said second identifier, associate said second identifier with the first identifier in response to said trigger event, and store said second identifier associated with said first identifier in said datastore.

18. A user device operable to communicate with at least one server of a gaming system via a communication link, the server having at least one processor and at least one memory connected to at least one database holding a data structure storing a plurality of user identities, the user device having at least one processor and at least one memory storing at least a first user identifier, one set of game data associated with a gaming application and the first user identifier, wherein the user device provides a second user identifier as a trigger event to the server.

19. A user device according to claim 18, wherein a common set of game data associated with the first and second identifier is updated upon detection of said trigger event to provide the common set of game data.

20. Computer program code on a carrier, which when executed by at least one processor of a server, causes the at least one processor to:
detect a trigger event associated with a second user identity, the trigger event providing the second user identity different to a first user identifier,
associate the second user identifier with said first user identifier, and
provide for at least one game associated with the first user identifier and the second user identifier a common set of game data.
